(19) United States
(12) Patent Application Publication
(10) Pub. No.: US 2025/0356768 A1
(43) Pub. Date: Nov. 20, 2025

(54) EDUCATIONAL CASE STUDY MEDIA CONTENT CREATION BASED ON CROWDSOURCE INFORMATION COLLECTIONS

(71) Applicant: International Business Machines Corporation, Armonk, NY (US)

(72) Inventors: Sarbajit K. Rakshit, Kolkata (IN); Manikandan Padmanaban, Chennai (IN); Jagabondhu Hazra, Bangalore (IN)

(21) Appl. No.: 18/663,480

(22) Filed: May 14, 2024

(51) Int. Cl. G09B 5/02; G06F 16/735; G06F 16/9536; G06T 15/08; G11B 27/10

(52) U.S. Cl. CPC G09B 5/02; G06F 16/735; G06F 16/9536; G06T 15/08; G11B 27/10

(57) ABSTRACT

In an approach for creating educational case study content based on crowdsourced media content, a processor receives a request for a video to be used with a case study and determines one or more requirements for the video. Based on the one or more requirements, the processor retrieves a plurality of crowdsourced videos from a social media network and determines at least one set of the plurality of crowdsourced videos that can form a closed loop contour. The processor further, based on the at least one set of the plurality of crowdsourced videos, creates the video to be used with the case study.

### BACKGROUND OF THE INVENTION

The present invention relates generally to the field of data processing, and more particularly to a computer-implemented method, a computer system, and a computer program product configured and arranged for creating educational case study media content based on collecting crowdsourced information.

Various disciplines have employed case studies, including humanities, social sciences, sciences, engineering, law, business, and medicine. Case studies are stories that are used as a teaching tool to show the application of a theory or concept to real situations. Depending on the goal they are meant to fulfill, cases can be fact-driven and deductive where there is a correct answer, or they can be context driven where multiple solutions are possible. Often when creating educational case study content, a real-life contextual scenario is used, for example, a scenario of a rescue operation at a live event can be studied. In order to create case study content, the use of various video technology is often used, including volumetric video technology. Volumetric video technology leverages cameras and advanced data processing to render three-dimensional (3D) images from a virtual space, which allows for video points of view to be generated from any angle within that space to create a more immersive experience for viewers. Volumetric video involves data processing of content feeds from multiple cameras from various directions to create a volume of video. However, the usefulness and quality of any volumetric video is dependent on how many directional videos are considered and their respective quality of video, and the processing engine which generates the volumetric video.

### SUMMARY

Aspects of an embodiment of the present invention disclose a method, computer program product, and computer system for creating educational case study content based on crowdsourced media content. The embodiment may include a processor receiving a request for a video to be used with a case study and determining one or more requirements for the video. The embodiment may include, based on the one or more requirements, the processor retrieving a plurality of crowdsourced videos from a social media network and determining at least one set of the plurality of crowdsourced videos that can form a closed loop contour. The embodiment may further include, based on the at least one set of the plurality of crowdsourced videos, the processor creating the video to be used with the case study.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of a content creation program, on a server within the distributed data processing environment of FIG. 1, in accordance with an embodiment of the present invention;

FIG. 3 is a flowchart illustrating, in greater detail, the operational steps of a search query construction component of the content creation program, on the server within the distributed data processing environment of FIG. 1, in accordance with an embodiment of the present invention;

FIG. 4 is a flowchart illustrating, in greater detail, the operational steps of a crowdsourced media content identification component of the content creation program, on the server within the distributed data processing environment of FIG. 1, in accordance with an embodiment of the present invention;

FIG. 5 is a flowchart illustrating, in greater detail, the operational steps of a volumetric video creation component of the content creation program, on the server within the distributed data processing environment of FIG. 1, in accordance with an embodiment of the present invention; and

FIG. 6 depicts a block diagram of components of a computing environment representing the distributed data processing environment of FIG. 1, in accordance with an embodiment of the present invention.

### DETAILED DESCRIPTION

Embodiments of the present invention recognize the need for a system and method by which an organization requiring a case study, for example, an educational institute, can define the requirement of the case study, and accordingly social media data will be analyzed to generate volumetric case study media content which can then be consumed, for example, in a Virtual Reality (“VR”) environment. An advantage of embodiments of the present invention is, in obtaining content for a volumetric video creation, crowdsource information gathering is an effective way of gathering input, and different crowdsource users can capture a geographic area from different directions.

Therefore, embodiments of the present invention provide a system and method that, based on an identified need of case study content for any topic, determine required parameters for case study content to find appropriate media content in a social media network site. Parameters for a case study may include, for example, a context to use in the case study, a coverage area, a duration of the case study content, and/or a location/geography. Embodiments of the present invention recognize an advantage in analyzing metadata of the crowdsourced media content to identify which sets of content form a closed loop contour, are captured in the same time frame, and match parameters of the case study. Metadata that is analyzed may include, for example, a location of capture, a direction of capture, a time range of capture, and/or a duration of capture. Embodiments of the present invention create volumetric video content for the case study.

More specifically, embodiments of the present invention recognize that, based on the requirements of the case study, advantages are obtained by performing a comparative evaluation of crowdsourced media content based at least on quality (e.g., pixel density, stable frames, zoom level) and the duration, and select which media content is to be considered for the case study creation. Further, an additional advantage is realized wherein embodiments of the present invention identify one or more closed loop contour(s) with consideration of the case study requirements and provide comparative differences among the identified closed loop contours, so an appropriate number of closed loop contours will be selected to create the volumetric video content. In embodiments of the present invention, once the video content is created, the video content can be provided in a Virtual Reality (VR) collaborative content for navigation and use by those reviewing the case study, for example, students at an educational institute such as a university.

Implementation of embodiments of the present invention may take a variety of forms, and exemplary implementation details are discussed subsequently with reference to the Figures.

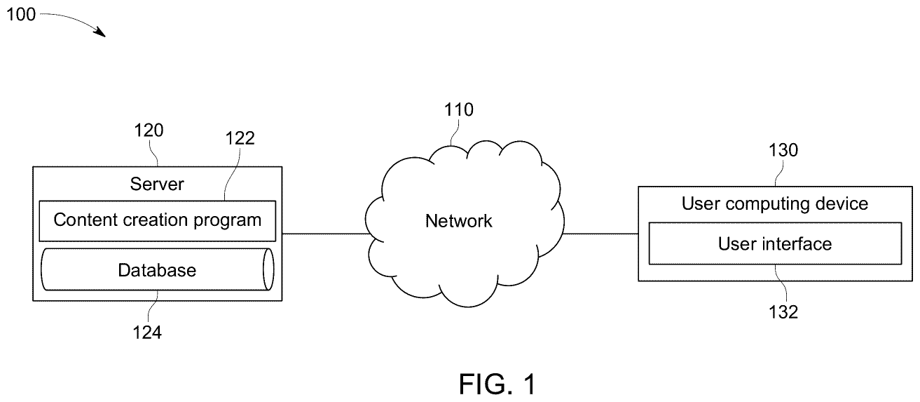

FIG. 1 is a block diagram illustrating a distributed data processing environment, generally designated 100, in accordance with an embodiment of the present invention. In the depicted embodiment, distributed data processing environment 100 includes server 120 and user computing device 130, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, and other computing devices (not shown) within distributed data processing environment 100.

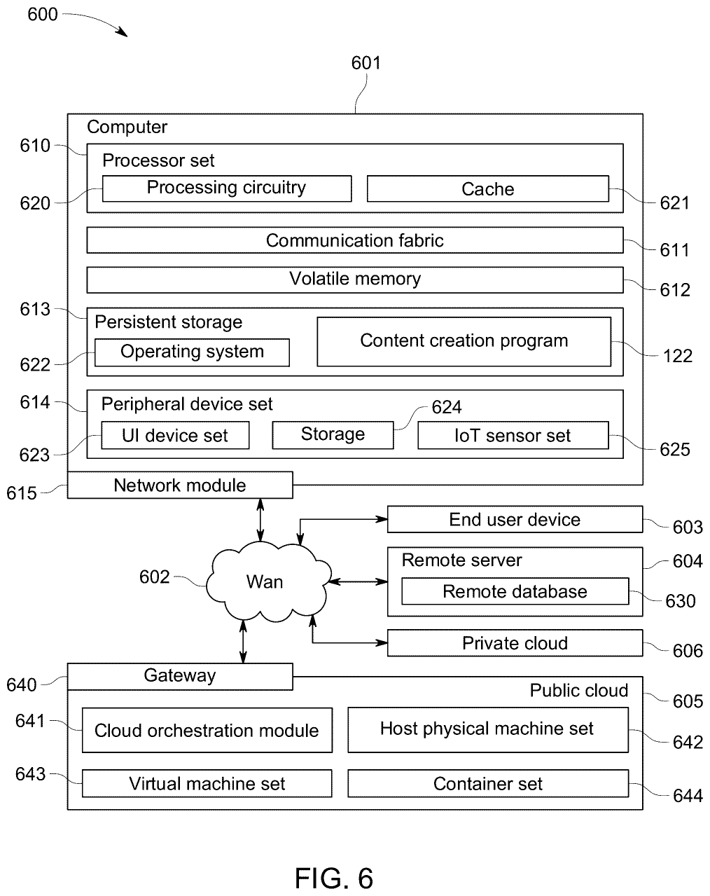

Server 120 operates to run content creation program 122 and to send and/or store data in database 124. In an embodiment, server 120 can send data from database 124 to user computing device 130. In an embodiment, server 120 can receive data in database 124 from user computing device 130. In an embodiment, server 120 includes content creation program 122 and database 124. In one or more embodiments, server 120 can be a standalone computing device, a management server, a web server, a mobile computing device, or any other electronic device or computing system capable of receiving, sending, and processing data and capable of communicating with user computing device 130 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130 and other computing devices (not shown) within distributed data processing environment 100 via network 110. Server 120 may include internal and external hardware components, as depicted and described in further detail in FIG. 6.

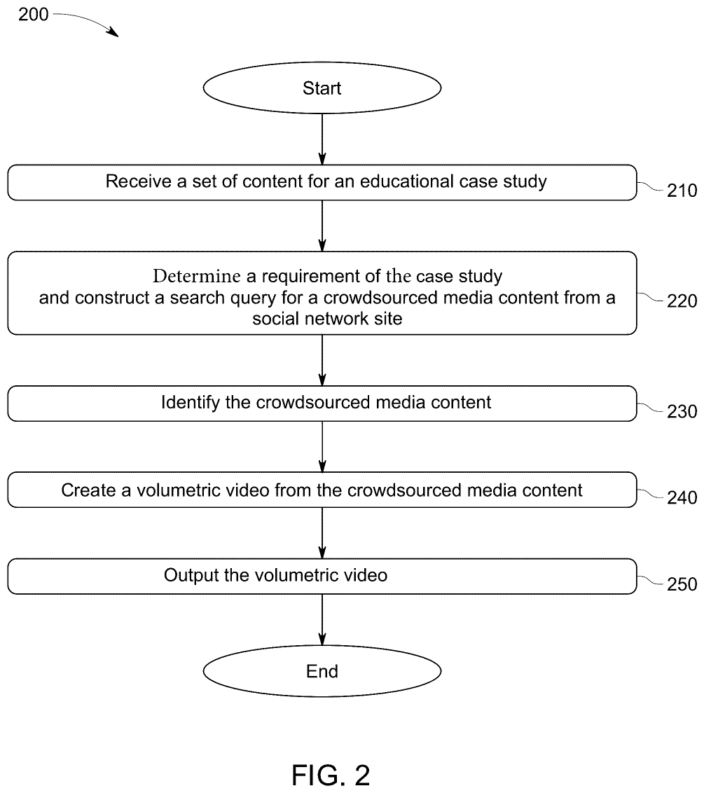

Content creation program 122 operates to determine requirements of an educational case study and to gather data from a social media network to generate volumetric video content for the case study to be consumed in a virtual reality environment. In the depicted embodiment, content creation program 122 is a standalone program. In another embodiment, content creation program 122 may be integrated into another software product. The operational steps of content creation program 122 are depicted and described in further detail with respect to FIGS. 2-5.

In an embodiment, a user of a user computing device (e.g., user computing device 130) registers with content creation program 122 of server 120. For example, the user completes a registration process (e.g., user validation), provides information to create a user profile, and authorizes the collection, analysis, and distribution (i.e., opts-in) of relevant data on an identified computing device (e.g., user computing device 130) by server 120 (e.g., via content creation program 122). Relevant data includes, but is not limited to, personal information or data provided by the user; tagged and/or recorded location information of the user (e.g., to infer context (i.e., time, place, and usage) of a location or existence); time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by content creation program 122. A database is an organized collection of data. Data includes, but is not limited to, information about user preferences (e.g., general user system settings such as alert notifications for a user computing device (e.g., user computing device 130)) and/or data generated by content creation program 122.

Database 124 can be implemented with any type of device capable of storing data and configuration files that can be accessed and utilized by server 120, such as a hard disk drive, a database server, or a flash memory. In an embodiment, database 124 is accessed by content creation program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that content creation program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. In embodiments of the present invention, content creation program 122 enables the authorized and secure processing of personal data and/or confidential company data.

In embodiments of the present invention, content creation program 122 provides informed consent, with notice of the collection of personal and/or confidential company data, allowing the user to opt-in or opt-out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. In embodiments of the present invention, content creation program 122 provides information regarding personal and/or confidential company data and the nature (e.g., type, scope, purpose, duration, etc.) of the processing. In embodiments of the present invention, content creation program 122 provides the user with copies of stored personal and/or confidential company data. In embodiments of the present invention, content creation program 122 allows the correction or completion of incorrect or incomplete personal and/or confidential company data. In embodiments of the present invention, content creation program 122 allows for the immediate deletion of personal and/or confidential company data.

In embodiments of the present invention, user computing device 130 represents a user device of any of a number of social media users providing content to a social media site for use by content creation program 122. User computing device 130 operates to run user interface 132 through which a user can interact with content creation program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running user interface 132 and of communicating (i.e., sending and receiving data) with content creation program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 include an instance of user interface 132.

User interface 132 operates as a local user interface between content creation program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from content creation program 122 to a user via network 110. User interface 132 can also display or present alerts including information (such as graphics, text, and/or sound) sent from content creation program 122 to a user via network 110. In an embodiment, user interface 132 can send and receive data (i.e., to and from content creation program 122 via network 110, respectively). Through user interface 132, a user can opt-in to provide content to a social media site; input information; create a user profile; set user preferences and alert notification preferences; receive a request for feedback; and input feedback. In embodiments of the present invention, through user interface 132, a user can opt-in to providing content to content creation program 122.

A user preference is a setting that can be customized for a particular user. A set of default user preferences can be assigned to each user of content creation program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of content creation program 122.

FIG. 2 is a flowchart, generally designated 200, illustrating the operational steps for content creation program 122, on server 120 within distributed data processing environment 100 of FIG. 1, in accordance with an embodiment of the present invention. In an embodiment, content creation program 122 operates to determine requirements of an educational case study and to gather data from a social media network to generate volumetric video content for the case study to be consumed in a virtual reality environment. It should be appreciated that the process depicted in FIG. 2 illustrates one possible iteration of the process flow, which may be repeated in a polling fashion (e.g., once a single active session or once over a plurality of active sessions) or in an on-demand fashion (e.g., whenever a user requests).

In an embodiment, content creation program 122 analyzes a media content available within a social media network. In embodiments of the present invention, the media content is one or more videos uploaded by users of the social media network. In an embodiment, media content is a crowdsourced media content published on a social media network by a social media user. In an embodiment, content creation program 122 enables a social media network to analyze a media content subsequently to the media content being published to a social media network. In an embodiment, content creation program 122 enables a social media network to analyze a media content to identify a context of the media content. In an embodiment, content creation program 122 enables a social media network to analyze a media content to identify an object present in the media content. In an embodiment, content creation program 122 enables a social media network to analyze a media content to identify an activity being performed in the media content. In an embodiment, content creation program 122 enables a social media network to derive a set of metadata from the media content. In an embodiment, a set of metadata derived from the media content includes, but is not limited to, a context of the media content, an object present in the media content, an activity being performed in the media content, and a criticality of the media content.

In an embodiment, content creation program 122 enables a social media network to analyze a media content to identify a set of camera specific information. In an embodiment, content creation program 122 enables a social media network to derive a set of camera specific information. In an embodiment, content creation program 122 enables a social media network to derive a set of camera specific information regarding the camera that captured the media content. In an embodiment, content creation program 122 enables a social media network to derive a set of camera specific information from the media content. The camera specific information derived from the media content includes, but is not limited to, a direction of capture (i.e., from a set of compass data), a location of capture, a timing of capture, a duration of capture, and an angular direction of capture.

In an embodiment, content creation program 122 enables the social media network to store the media content. In an embodiment, content creation program 122 enables the social media network to store the media content (e.g., as the published picture content or as the published video content) in a database (e.g., database 124). In an embodiment, content creation program 122 enables the social media network to store the set of metadata derived from the media content in a database (e.g., database 124). In an embodiment, content creation program 122 enables the social media network to store the camera specific information derived from the media content in a database (e.g., database 124). In an embodiment, content creation program 122 enables the social media network to make the media content, the set of metadata derived from the media content, and the camera specific information derived from the media content searchable.

Referring to flowchart 200, at step 210, content creation program 122 receives a set of content for an educational case study. In an embodiment, content creation program 122 receives a set of content including, for example, a request to create a media-based case study for an educational topic. In an embodiment, content creation program 122 receives a request from a user. A user includes, but is not limited to, an educational institute. In an embodiment, content creation program 122 receives a request from a user via a user interface (e.g., user interface 132) of a user computing device (e.g., user computing device 130).

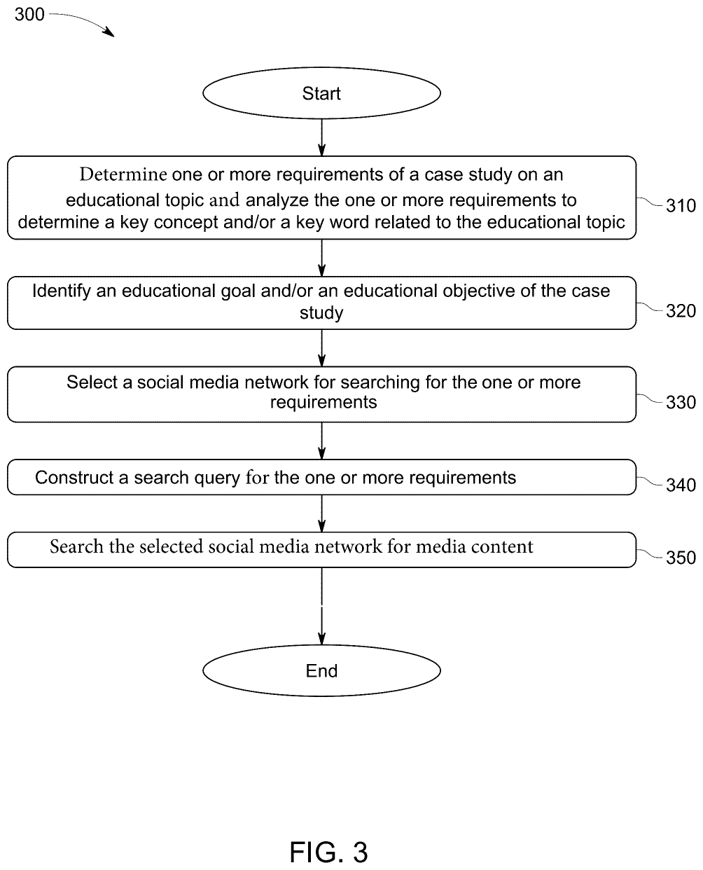

At step 220, content creation program 122 determines one or more requirements of the media-based case study for the educational topic and constructs a search query for crowdsourced media content from a social media network site. The search query construction component of step 220 is described in further detail with respect to flowchart 300 in FIG. 3.

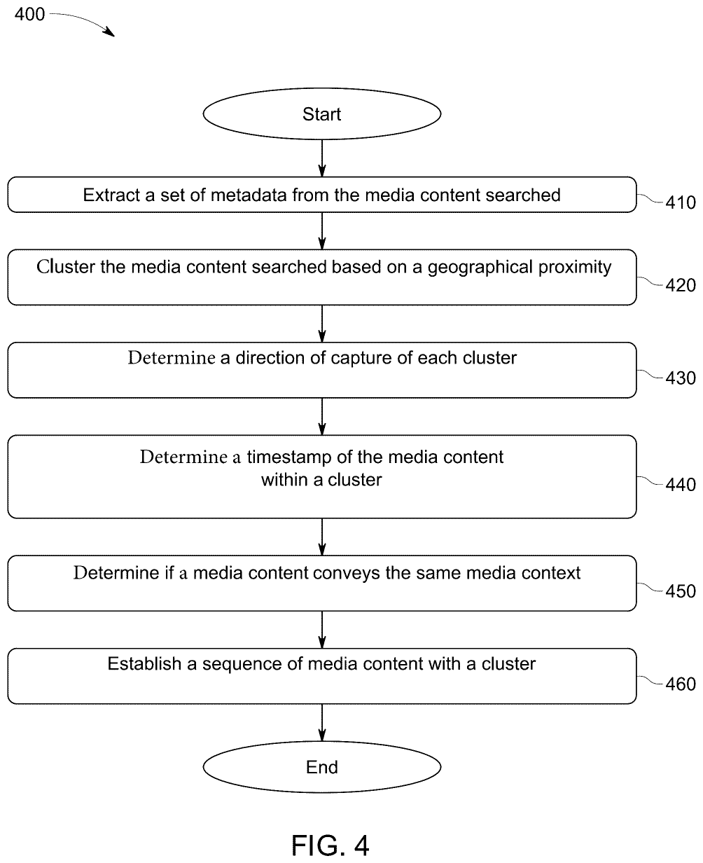

At step 230, content creation program 122 identifies the crowdsourced media content using the constructed search query. In an embodiment, content creation program 122 performs an initial search of a social media network using the constructed search query to identify media content meeting the requirements of the media-based case study. In an embodiment, the media content identified is a plurality of crowdsourced videos from users of the social media network site. The crowdsourced media content identification component of step 230 is described in further detail with respect to flowchart 400 in FIG. 4.

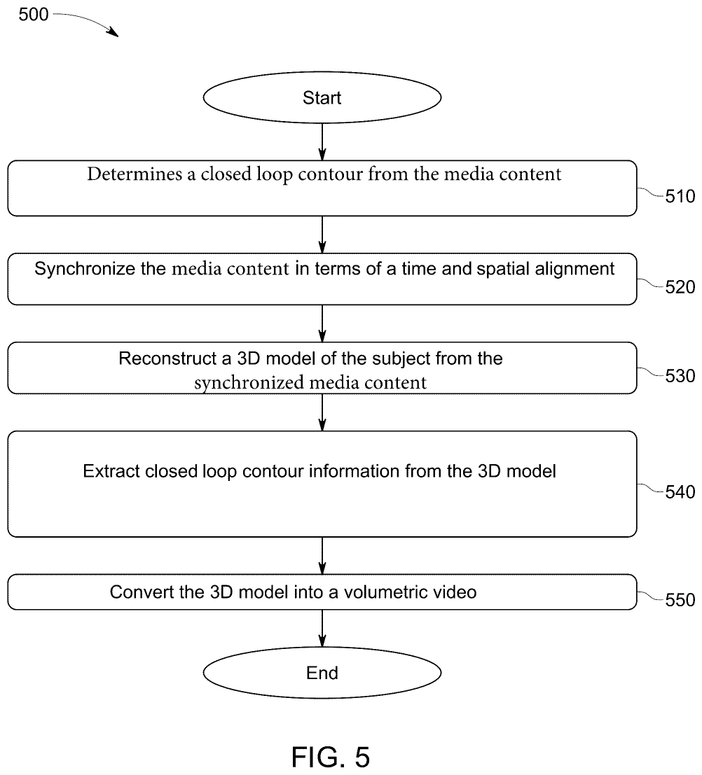

At step 240, content creation program 122 creates a volumetric video from the crowdsourced media content. In an embodiment of the present invention, content creation program 122 identifies, from the crowdsourced media content, a set of media-based content to be used to form a closed loop contour. In an embodiment, the set of media-based content to be used to form the closed loop contour is identified considering one or more factors regarding the capture, including, for example, at least a location of capture, a direction of capture, and a timing of capture. The volumetric video creation component of step 240 is described in further detail with respect to flowchart 500 in FIG. 5.

At step 250, content creation program 122 outputs the volumetric video. In an embodiment, content creation program 122 outputs the volumetric video to the user. In an embodiment, content creation program 122 outputs the volumetric video to the user via the user interface (e.g., user interface 132) of the user computing device (e.g., user computing device 130). In an embodiment of the present invention, content creation program 122 requests a set of feedback. In an embodiment, content creation program 122 requests a set of feedback from the user. In an embodiment, content creation program 122 requests a set of feedback regarding the volumetric video.

FIG. 3 is a flowchart, generally designated 300, illustrating, in greater detail, the operational steps of a search query construction component (e.g., step 220) of content creation program 122, on server 120 within distributed data processing environment 100 of FIG. 1, in accordance with an embodiment of the present invention. In an embodiment, content creation program 122 operates to identify one or more requirements of a set of content such as a media-based case study and construct a search query to gather the set of media-based content from a social media network site (i.e., from a crowd-source). It should be appreciated that the process depicted in FIG. 3 illustrates one possible iteration of the process flow, which may be repeated each time a search query is to be conducted.

At step 310, content creation program 122 determines one or more requirements of a case study on an educational topic and analyzes the one or more requirements to determine a key concept and/or a key word related to the educational topic. In an embodiment, content creation program 122 analyzes the content for the educational case study received in step 210 to identify one or more requirements for the case study. In an embodiment, content creation program 122 enables the user to define one or more requirements of the set of media-based content. A requirement is a parameter or a set of parameters that are required to be included in a set of media-based content for an educational case study on an educational topic. A parameter or a set of parameters include, but are not limited to, a context of an educational case study, a topic of an educational case study, a level of criticality of an educational case study, a boundary of coverage of an educational case study, a geographical boundary of coverage of an educational case study, and a duration of coverage of an educational case study. In an embodiment, content creation program 122 analyzes the identified one or more requirements to determine at least one of a key concept, a keyword, and a key phrase related to the educational topic of the educational case study.

At step 320, content creation program 122 identifies an educational goal and/or an educational objective of the case study. In an embodiment, content creation program 122 analyzes the one or more determined requirements to ensure the educational goal (i.e., the objective) aligns with an audience targeted. In an embodiment, content creation program 122 analyzes the one or more requirements to ensure the educational goal (i.e., the objective) aligns with the set of media-based content sought. In an embodiment, content creation program 122 analyzes the one or more requirements to determine a set of parameters associated with the at least one of a key concept, a keyword, and a key phrase related to the educational topic of the educational case study.

At step 330, content creation program 122 selects a social media network to be searched for the identified one or more requirements. In an embodiment, content creation program 122 selects a social media network that is typically used to post media-based content related to the educational topic. In an embodiment, content creation program 122 selects a social media network that receives videos on a regular basis from multiple users.

At step 340, content creation program 122 constructs a search query for the one or more requirements of the educational case study on the social media network selected. In an embodiment, content creation program 122 identifies at least one of one or more key words and one or more key phrases of the educational topic of the educational case study. In an embodiment, content creation program 122 identifies at least one of one or more key words and one or more key phrases of the one or more requirements of the set of media-based content needed for the educational case study and constructs a search query.

At step 350, content creation program 122, using the constructed search query, searches the selected social media network for media content. In an embodiment, content creation program 122 reviews the initial search results and filters based on relevance to the case study requirements, quality of video, and suitability for the case study. In an embodiment of the present invention, content creation program 122 retrieves two or more crowdsourced videos from the social media network site that meet the case study requirements based on the videos being captured in a same time frame. In an embodiment, content creation program 122 refines the search query by using a combination of operators. A combination of operators may include, but are not limited to, “and”, “or”, and “not”. In an embodiment, content creation program 122 refines the search query by including one or more synonyms of the at least one of the one or more key words and the one or more key phrases. In an embodiment, content creation program 122 refines the search query by including one or more variations of the at least one of the one or more key words and the one or more key phrases. In an embodiment, content creation program 122 refines the search query by including one or more hashtags in the search query. In an embodiment, content creation program 122 refines the search query by including one or more social media-specific search elements in the search query. In an embodiment, content creation program 122 refines the search query to optimize the search results. In a further embodiment, content creation program 122 continuously searches at least one social media site for additional applicable crowdsourced videos that may have, for example, different time frames, comparatively better quality, or increased boundary coverage.

FIG. 4 is a flowchart, generally designated 400, illustrating, in greater detail, the operational steps of a crowdsourced media content identification component of content creation program 122, on server 120 within distributed data processing environment 100 of FIG. 1, in accordance with an embodiment of the present invention. It should be appreciated that the process depicted in FIG. 4 illustrates one possible iteration of the process flow, which may be repeated each time a search is completed.

Following the steps discussed at step 220 of FIG. 2, and the steps discussed with respect to FIG. 3, content creation program 122, at step 410, extracts a set of metadata from the media content searched. In embodiments of the present invention, the media content obtained from the search of the social media network is a plurality of crowdsourced videos. The set of metadata of the media-based content gathered during the initial search may include, but is not limited to, a content type of the media-based content (i.e., text, images, and videos), a date of capture of the media-based content, a time of capture of the media-based content (e.g., a timestamp), a location of capture of the media-based content (e.g., a set of GPS coordinates), a direction of capture of the media-based content (e.g., an orientation and a corresponding set of metadata from one or more sensors of a device), a specification of a camera used to capture the media-based content, a time of posting of the media-based content, a user engagement, and a set of additional details regarding the media-based content. In an embodiment, content creation program 122 classifies the media-based content based on the set of metadata analyzed.

At step 420, content creation program 122 clusters the media content searched using the extracted metadata. In an embodiment, content creation program 122 clusters the media content into one or more clusters based on a geographical proximity. The geographical proximity may be, but is not limited to, a pre-set threshold distance from, for example, an event, a location, or another media content. In an embodiment, content creation program 122 clusters the media content extracted using a set of GPS coordinates. In a further embodiment, content creation program 122 clusters the media content based on determining at least two crowdsourced videos captured in a same time frame that meet the one or more requirements for the case study video.

At step 430, content creation program 122 determines a direction of capture of each cluster. In an embodiment, content creation program 122 determines an orientation of a camera capturing the media content in each cluster. In another embodiment, content creation program 122 determines an angle of a camera capturing the media content in each cluster. In an embodiment, content creation program 122 determines an orientation of a camera capturing the media content by using a set of orientation metadata. In another embodiment, content creation program 122 determines an orientation of a camera capturing the media content by analyzing one or more recognizable landmarks in the media content (e.g., roads, buildings). In another embodiment, content creation program 122 determines an orientation of a camera capturing the media content by using a specification of a camera used to capture the media content. In another embodiment, content creation program 122 determines an orientation of a camera capturing the media content by using a direction of capture of the media content (e.g., a set of compass direction data captured from one or more sensors of a device).

At step 440, content creation program 122 determines a timestamp of the media content within a cluster. In an embodiment, content creation program 122 determines a time difference by calculating a time difference between two or more consecutive time stamps extracted in the metadata of each media content.

At step 450, content creation program 122 determines whether any media content conveys the same media context as another content. The media-based content in each cluster may be, but is not limited to, close in geographical proximity, have a similar direction of capture, and have a similar time range of capture. In an embodiment, content creation program 122 analyzes the media content in each cluster to determine if the media-based content conveys the same media context as another media content.

At step 460, content creation program 122 establishes a sequence of media content within a cluster. In an embodiment, content creation program 122 establishes a sequence of the media-based content within a cluster based on at least one of a directional analysis and a temporal analysis. In an embodiment, content creation program 122 established a chronological order of capture of one or more crowdsourced videos.

FIG. 5 is a flowchart, generally designated 500, illustrating, in greater detail, the operational steps of a volumetric video creation component of content creation program 122, on server 120 within distributed data processing environment 100 of FIG. 1, in accordance with an embodiment of the present invention. In an embodiment, content creation program 122 operates to create a volumetric video from the crowd-sourced media content. It should be appreciated that the process depicted in FIG. 5 illustrates one possible iteration of the process flow.

Following the steps discussed at step 230 of FIG. 2, and the steps discussed with respect to FIG. 4, content creation program 122, at step 510, determines a closed loop contour from the media content. In an embodiment, content creation program 122 identifies content that forms closed loop contours and connects the different video content to create a coherent narrative. In an embodiment, content creation program 122 analyzes the sequence of media content within a cluster and determines one or more crowdsourced videos of the media content that can form a closed loop contour of a subject by considering at least a location of capture, a direction of capture, and a timing of capture. In an embodiment, content creation program 122 determines whether the sequence forms a closed loop by comparing a start point and an end point of the sequence. In an embodiment, content creation program 122 determines the sequence forms a closed loop if the start point and the end point are close (i.e., in terms of location) and if the sequence forms a reasonable path from the start point to the end point. In an embodiment, the user, i.e., the education institute, selects an appropriate closed loop contour for the case study. In an embodiment, content creation program 122 performs a comparative evaluation of each set of the one or more crowdsourced videos that can form a closed loop contour and identifies which set has a higher quality than others based on, at least, duration of video, coverage area of video, and video quality of the video.

In various embodiments of the present invention, content creation program 122 identifies approximate closed loop contours. In an embodiment, the process of creating a closed loop contour by joining multiple points can be represented mathematically where each point, Pᵢ, consists of a location and a direction vector. To create a closed loop contour, content creation program 122 interpolates each point sequentially, for example, using a linear interpolation formula to connect two or more points Pᵢ and Pᵢ₊₁, and connecting the last point, Pₙ back to the first point P₁.

At step 520, content creation program 122 synchronizes the media content in terms of a time and a spatial alignment. In an embodiment, content creation program 122 synchronizes the media content, for example, the one or more crowdsourced videos, utilizing at least one of a synchronization marker, a timestamp, or a visual cue.

At step 530, content creation program 122 reconstructs a three-dimensional (3D) model of the subject from the synchronized media content. In an embodiment, content creation program 122 utilizes a Structure from Motion (SfM) technique to reconstruct a 3D model of the subject from the synchronized media content. In another embodiment, content creation program 122 utilizes a Multi-View Stereo (MVS) technique to reconstruct a 3D model of the subject from the synchronized media content. In an embodiment, content creation program 122 analyzes one or more frames of the synchronized media content, i.e., the crowdsourced videos, to create a 3D point cloud or mesh.

At step 540, content creation program 122 extracts closed loop contour information from the 3D model. In an embodiment, content creation program 122 analyzes the media content which create the closed-loop contour and extracts the closed loop contour information from the 3D model. In an embodiment, content creation program 122 extracts the closed loop contour information from the 3D model by identifying a silhouette of the subject in each frame of the reconstructed 3D model.

In an embodiment, content creation program 122 verifies a consistency of each closed loop contour across the synchronized one or more crowdsourced videos. In an embodiment, content creation program 122 ensures that the contours align seamlessly and create a continuous loop based on the metadata information. In an embodiment, content creation program 122 estimates a set of information regarding a depth of each point on the closed-loop contour. In an embodiment, content creation program 122 estimates a set of information using at least one of a stereo matching technique, a depth sensor, or a depth estimation method.

At step 550, content creation program 122 converts the 3D model with into a volumetric video. In an embodiment, content creation program 122 converts the 3D model with a textured mapping into the volumetric video format. In an embodiment, content creation program 122 utilizes the volumetric video format to store the 3D geometry and the texture information of each frame. The volumetric video is then output to the user as discussed with respect to FIG. 2 at step 250.

FIG. 6 depicts a block diagram of components of server 120 within distributed data processing environment 100 of FIG. 1, in accordance with an embodiment of the present invention. It should be appreciated that FIG. 6 provides only an illustration of one implementation and does not imply any limitations with regard to the environments in which different embodiments can be implemented. Many modifications to the depicted environment can be made.

Computing environment 600 contains an example of an environment for the execution of at least some of the computer code involved in performing the inventive methods, such as content creation program 122. In addition to content creation program 122, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and content creation program 122, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

Computer 601, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

Processor set 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in content creation program 122 in persistent storage 613.

Communication fabric 611 is the signal conduction paths that allow the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 612 is any type of volatile memory now known or to be developed in the future. Examples include dynamic type random access memory (RAM) or static type RAM. Typically, the volatile memory is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

Persistent storage 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid-state storage devices. Operating system 622 may take several forms, such as various known proprietary operating systems or open-source Portable Operating System Interface type operating systems that employ a kernel. The code included in content creation program 122 typically includes at least some of the computer code involved in performing the inventive methods.

Peripheral device set 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

Network module 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 603 is any computer system that is used and controlled by an end user (for example, a customer of an enterprise that operates computer 601) and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

Remote server 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

Public cloud 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1. A computer-implemented method comprising:
receiving a request for a video;
determining one or more requirements for the video;
retrieving, based on the one or more requirements, a plurality of crowdsourced videos from a social media network;
extracting a set of metadata from the plurality of crowdsourced videos, the set of metadata including geographical and temporal information;
clustering the plurality of crowdsourced videos into location clusters based on a geographical proximity;
determining, based on the temporal information, a chronological sequence of clustered videos within the location clusters;
determining a first temporal image set of the plurality of crowdsourced videos that form a closed loop contour at a given time and at a target location; and
creating the video including sequentially arranging multiple temporal image sets including the first temporal image set, the video meeting the one or more requirements.

2. The computer-implemented method of claim 1, wherein retrieving the plurality of crowdsourced videos from the social media network includes:
determining, based on the one or more requirements, a search query for the social media network.

3. The computer-implemented method of claim 1, wherein retrieving the plurality of crowdsourced videos from the social media network includes:
determining a plurality of videos captured at a concurrent time, the plurality of videos meeting the one or more requirements for the video.

4. (canceled)

5. The computer-implemented method of claim 1, wherein the set of metadata of the plurality of crowdsourced videos includes a location of capture, a direction of capture, and a timing of capture.

6. The computer-implemented method of claim 1, wherein creating the video further comprises:
synchronizing temporal image sets in terms of a temporal and a spatial alignment;
reconstructing a three-dimensional (3D) model from the synchronized temporal image sets;
extracting closed-loop contour information from the 3D model; and
converting the 3D model to a volumetric video.

7. (canceled)

8. A computer program product comprising one or more computer readable storage media and program instructions stored therein, which, when executed by a processor, causes the processor to perform a method comprising:
receiving a request for a video;
determining one or more requirements for the video;
retrieving, based on the one or more requirements, a plurality of crowdsourced videos from a social media network;
extracting a set of metadata from the plurality of crowdsourced videos, the set of metadata including geographical and temporal information;
clustering the plurality of crowdsourced videos into location clusters based on a geographical proximity;
determining, based on the temporal information, a chronological sequence of clustered videos within the location clusters;
determining a first temporal image set of the plurality of crowdsourced videos that form a closed loop contour at a given time and at a target location; and
creating the video including sequentially arranging multiple temporal image sets including the first temporal image set, the video meeting the one or more requirements.

9. The computer program product of claim 8, wherein retrieving the plurality of crowdsourced videos from the social media network includes:
determining, based on the one or more requirements, a search query for the social media network.

10. The computer program product of claim 8, wherein retrieving the plurality of crowdsourced videos from the social media network further comprises includes:
determining a plurality of videos captured at a concurrent time, the plurality of videos meeting the one or more requirements for the video.

11. (canceled)

12. The computer program product of claim 8, wherein the set of metadata of the plurality of crowdsourced videos includes a location of capture, a direction of capture, and a timing of capture.

13. The computer program product of claim 8, wherein creating the video further comprises:
synchronizing the temporal image sets in terms of a temporal and a spatial alignment;
reconstructing a three-dimensional (3D) model from the synchronized temporal image sets;
extracting the closed loop contour from the 3D model; and
converting the 3D model to a volumetric video.

14. (canceled)

15. A computer system comprising:
one or more computer processors;
one or more computer readable storage media;
wherein:
the one or more computer processors are structured, located, connected, and/or programmed to run program instructions on the one or more computer readable storage media; and
the program instructions, which, when executed by at least one processor of the one or more computer processors, cause the at least one processor to perform a method comprising:
receiving a request for a video;
determining one or more requirements for the video;
retrieving, based on the one or more requirements, a plurality of crowdsourced videos from a social media network;
extracting a set of metadata from the plurality of crowdsourced videos, the set of metadata including geographical and temporal information;
clustering the plurality of crowdsourced videos into location clusters based on a geographical proximity;
determining, based on the temporal information, a chronological sequence of clustered videos within the location clusters;
determining a first temporal image set of the plurality of crowdsourced videos that form a closed loop contour at a given time and at a target location; and
creating the video including sequentially arranging multiple temporal image sets including the first temporal image set, the video meeting the one or more requirements.

16. The computer system of claim 15, wherein retrieving the plurality of crowdsourced videos from the social media network includes:
determining, based on the one or more requirements, a search query for the social media network.

17. (canceled)

18. The computer system of claim 15, wherein the set of metadata of the plurality of crowdsourced videos includes a location of capture, a direction of capture, and a timing of capture.

19. The computer system of claim 15, wherein creating the video further comprises:
synchronizing the temporal image sets in terms of a temporal and a spatial alignment;
reconstructing a three-dimensional (3D) model from the synchronized temporal image sets;
extracting the closed loop contour from the 3D model; and
converting the 3D model to a volumetric video.

20. (canceled)

21. The computer-implemented method of claim 6, wherein extracting the closed loop contour information includes identifying a silhouette of an object in each frame of the video;

22. The computer-implemented method of claim 6, wherein converting the 3D model to a volumetric video includes:
verifying consistency of the closed loop contour information; and
creating a continuous loop based on the set of metadata.

23. The computer-implemented method of claim 1, wherein:
determining the first temporal image set includes identifying approximate closed loop contours by:
joining multiple points consisting of the target location and a direction vector, the multiple points including a first point and a last point; and
interpolating the multiple points sequentially using a linear interpolation formula starting with the first point and, finally, connecting the last point back to the first point.
